(19) United States
(12) Patent Application Publication
(10) Pub. No.: US 2007/0115595 A1
(43) Pub. Date: May 24, 2007

(54) CPP-TYPE THIN-FILM MAGNETIC HEAD AND MANUFACTURING METHOD THEREOF

(75) Inventors: Kenji Honda, Niigata-ken (JP); Naohiro Ishibashi, Niigata-ken (JP); Daigo Aoki, Niigata-ken (JP); Yasuo Hayakawa, Niigata-ken (JP); Yoshihiro Nishiyama, Niigata-ken (JP); Toshihiro Kobayashi, Niigata-ken (JP)

Correspondence Address: BRINKS HOFER GILSON & LIONE, P.O. BOX 10395, CHICAGO, IL, 60610, US

(73) Assignee: ALPS ELECTRIC CO., LTD., Tokyo (JP)

(21) Appl. No.: 11/558,345

(22) Filed: Nov. 9, 2006

(30) Foreign Application Priority Data
Nov. 18, 2005 (JP) 2005-334865

(51) Int. Cl. G11B 5/33; G11B 5/127

(52) U.S. Cl. 360/320; 360/324

(57) ABSTRACT

a CCP-type thin-film magnetic head and a manufacturing method thereof are provided. The CCP-type thin-film magnetic head includes a thin-film magnetic head element formed between the upper shield layer and the lower shield layer, and a side fill gap layer securing the insulating property, which is formed from both end faces of the thin-film magnetic head element, wherein a top surface of the lower shield layer is formed in a non-flat surface having a convex portion disposed at a center in a track width direction and a concave portion disposed at both sides in a track width direction of the convex portion, the thin-film magnetic head element is formed on the convex portion, and an buried gap layer contacting the side fill gap layer is formed in the concave portion.

This application claims the benefit of Japanese Patent Application No. 2005-334865 filed Nov. 18, 2005, which is hereby incorporated by reference.

### FIELD

The present embodiments relate to a CCP-type thin-film magnetic head and a manufacturing method thereof.

### BACKGROUND

A thin-film magnetic head mounted on a hard disk apparatus can be classified as a CIP (Current In the Plane) type in which a sense current flows in a direction parallel to a surface of each layer constituting the thin-film magnetic head element and a CPP (Current Perpendicular to the Plane) type in which the sense current flows in a direction perpendicular to the surface of each layer constituting the thin-film magnetic head element.

The CIP-type thin-film magnetic head is generally used as a product. However, since an output thereof is reduced with a reduction in track width, there are various problems in forming an even narrower track. In the CPP-type thin-film magnetic head, when a current density is kept constant, an output thereof is not varied in spite of reducing the track width. Accordingly, the CPP-type thin-film magnetic head, which has an output that does not depend on the track width, has a narrower track than the CIP-type thin-film magnetic head.

FIG. 7 is a cross-sectional view showing a structure of a known CPP-type thin-film magnetic head. The CPP-type thin-film magnetic head includes a lower shield layer (bottom electrode layer) 110, and a thin-film magnetic head element 120 formed on the lower shield layer 110. A side fill gap layer 140 is formed on the lower shield layer 110 in contact with both sides of the thin-film magnetic head element 120. A bias layer 141 and a cap layer 142 are stacked on the side fill gap layer 140. An upper shield layer (top electrode layer) 130 is formed on the thin-film magnetic head element 120 and the cap layer 142.

A GMR (Giant Magnetoresistive) element or a TMR (Tunneling Magnetoresistive) element is used as the thin-film magnetic head element 120. The side fill gap layer 140 is formed of an insulating material, for example, Al₂O₃ or SiO₂. The side fill gap layer 140 is an insulating layer that secures an insulating property of the lower shield layer 110 and the upper shield layer 130.

In the CPP-type thin-film magnetic head, the lower shield layer 110 and the upper shield layer 130 serve as electrode layers. When the sense current flows in a direction perpendicular to the film surface of the thin-film magnetic head element 120 from one side of the lower shield layer 110 and the upper shield layer 130 toward the other side thereof, a leakage flux from a storage medium can be detected by using a magnetoresistive effect of the thin-film magnetic head element 120.

[Patent Document 1] JP-A-2000-182223 (US Pub. No. 2001033462A1)

[Patent Document 2] JP-A-2002-353538

[Patent Document 3] JP-A-2001-344708

[Patent Document 4] JP-A-2001-331908

In the CPP-type thin-film magnetic head, due to a element structure, the side fill gap layer 140 can be only reduced by approximately several tens Å. Therefore, a pin hole could be easily generated and an insulation failure might occur between the lower shield layer 110 and the upper shield layer 130 due to the pin hole. When the insulation failure occurs between the lower shield layer 110 and the upper shield layer 130, the sense current flowing in the thin-film magnetic head element 120 decreases and a reproduction characteristic deteriorates.

### SUMMARY

The present embodiments may obviate one or more of the limitations of the related art. For example, in one embodiment, CPP-type thin-film magnetic head is capable of improving a reproduction characteristic by enhancing an electrical insulating property between an upper shield layer and a lower shield layer. However, the present embodiments are not limited to obviating the limitations of the discussed related art.

Generally, an insulating property between an upper shield layer and the lower shield layer is enhanced by interposing a different insulating layer between a lower shield layer and a side fill gap layer and that the thickness of the insulating layer is secured without jumboizing a head by burying the insulating layer on a top surface of the lower shield layer.

In one embodiment, a CPP-type thin-film magnetic head includes a thin-film magnetic head element formed between a lower shield layer and an upper shield layer. A side fill gap layer secures the insulating property of the lower shield layer and the upper shield layer. The side fill gap layer is formed from both end faces in a track width direction of the thin-film magnetic head element to the lower shield layer and a current flows in a direction perpendicular to a film surface of the thin-film magnetic head element.

In one embodiment, the top surface of the bottom shield layer is formed in a non-flat surface that has a convex portion disposed at a center in the track width direction and a concave portion disposed at both sides in the track width direction of the convex portion, the thin-film magnetic element is formed on the convex portion. A buried gap layer contacts the side fill gap layer formed in the concave portion.

In one exemplary embodiment, the buried gap layer is thicker than the side fill gap layer to sufficiently secure the insulating property.

In one embodiment, the convex portion of the lower shield layer has an extension region extending outwardly from the both end faces of the thin-film magnetic head element and contacting the side fill gap layer. The size of the extension region in the track width direction is about 1/10 times to 20 times the track width of the thin-film magnetic head element. In this embodiment, a region, which has the lower shield layer and the side fill gap layer directly contacting each other, can be narrowed as much as possible in this range. In this embodiment, the probability that an insulation failure will occur due to a defect of the side fill gap layer is reduced.

In one embodiment, the extension region of the lower shield layer has the surface roughness of about 30 Å or less. In this range, for example, the defect such as the pin hole is difficult to occur on the side fill gap layer stacked on the lower shield layer. Therefore, the insulation failure by the defect can be evaded.

In one embodiment, the top surface of the convex portion of the lower shield layer and the top surface of the buried gap layer are formed in the concave portion of the lower shield layer and are in the same plane. According to this embodiment, even if the buried gap layer is formed, the flatness of the top surface of the lower shield layer is secured and a bad effect is not given to each layer formed on the convex portion of the lower shield layer and the buried gap layer.

In one embodiment, the buried layer is formed of one or more types of insulating materials, for example, SiO2, Al₂O₃, Ta₂O₅, TiO, Ti₂O₃, Ti₃O₅, WO₃, Si₃N₄, AlN, AlSiO or SiAlON.

In another embodiment, a bias layer and a cap layer are sequentially stacked from the side fill gap layer side. The bias layer and the cap layer are interposed between the side fill gap layer and the upper shield layer.

According to another embodiment, a method of manufacturing a CPP-type thin-film magnetic head in which a current flows in a direction perpendicular to a film surface of a thin-film magnetic head element is provided. The method comprising the steps of: forming a first liftoff resist which defines the track width of the top surface of the lower shield layer, the first liftoff resist being disposed at the center in the track width direction on the lower shield layer; forming the top surface of the lower shield layer with a non-flat surface having the convex portion covered with the resist and the concave portion disposed at both sides in the track width direction of the convex portion by removing the lower shield layer not covered with the first resist up to a predetermined depth; forming the buried gap layer in the concave portion of the lower shield layer; exposing the convex portion of the lower shield layer by lifting off the first resist; forming a multilayer film constituting the thin-film magnetic head element on the convex portion and the buried gap layer of the lower shield layer; forming a second liftoff resist which defines the track width of the multilayer film; forming the multilayer film covered with the second resist layer with the thin-film magnetic head element by removing the multilayer film not covered with the second resist, and exposing a part of the convex portion and the buried gap layer of the lower shield layer to the removed par; forming the side fill gap layer, bias layer and cap layer on both end faces in the track width direction of the thin-film magnetic head element, and the exposed convex portion and buried gap layer of the lower shield layer; exposing the top surface of the thin-film magnetic head element by lifting off the second resist; and forming the upper shield layer on the thin-film magnetic head element.

In one embodiment, the lower shield layer is not covered with the first resist that is sharpened by etching and an inclination angle of the both end faces in the track width direction of the convex portion of the lower shield layer by an etching angle, thereby flattening the top surface of the buried gap layer formed in the concave portion of the lower shield layer.

In one embodiment, the lower shield layer is not covered with the first resist and is sharpened in a depth greater than the thickness of the side fill gap layer. Therefore, the buried gap layer has the film thickness so that the top surface of the buried gap layer and the top surface of the lower shield layer can be in the same plane. The thickness of the buried gap layer is sufficiently secured without drastically increasing the head, thereby improving the insulating property between the top shield and the bottom shield.

In the lower shield layer, it is practical that the size of the top surface of the lower shield layer in the track width direction is greater than the track width of the thin-film magnetic head element. The both end faces in the track width direction of the convex portion of the lower shield layer are disposed outwardly from the both end faces in the track width direction of the thin-film magnetic head element. For example, the extension region that extends from the both end faces of the thin-film magnetic head element contacting the side fill gap layer is formed, and the size in the track width direction is about 1/10 times to 20 times the size of the thin-film magnetic head element in the track width direction.

In one embodiment, since the insulating property of the side fill gap layer are improved by the buried gap layer formed on the top surface of the lower shield layer and a region directly contacted by the lower shield layer and the side fill gap layer decreases, the insulating property between the upper shield layer and the lower shield layer are improved, thereby acquiring the CPP-type thin-film magnetic head capable of improving the reproduction characteristic and the manufacturing method thereof.

### BRIEF DESCRIPTION OF THE DRAWING

FIG. 1 is a fragmentary cross-sectional view showing a structure of a thin-film magnetic head when viewed from a surface side opposite to a storage medium according to one embodiment.

FIG. 2 is a fragmentary cross-sectional view showing a portion of a CPP-type thin-film magnetic head.

FIG. 3 is a fragmentary cross-sectional view showing a portion of a CPP-type thin-film magnetic head when viewed from a surface side opposite to a storage medium.

FIG. 4 is a fragmentary cross-sectional view showing a portion of a CPP-type thin-film magnetic head when viewed from a surface side opposite to a storage medium.

FIG. 5 is a fragmentary cross-sectional view showing a portion of a CPP-type thin-film magnetic head when viewed from a surface side opposite to a storage medium.

FIG. 6 is a fragmentary cross-sectional view showing a portion of a CPP-type thin-film magnetic head when viewed from a surface side opposite to a storage medium.

FIG. 7 is a fragmentary cross-sectional view showing a CPP-type thin-film magnetic head of the known structure when viewed from a surface side opposite to a storage medium.

### DETAILED DESCRIPTION

Exemplary embodiments of a thin-film magnetic head will be described with reference to the drawings. In the respective drawings, the X-direction represents a track width direction. The Y-direction represents the height direction (direction of a leakage flux from a storage medium). The Z-direction represents the moving direction of the storage medium moves and the stacking direction of each layer constituting the thin-film magnetic head.

In one embodiment, a thin-film magnetic head 1 includes a thin-film magnetic head element 20 between a lower shield layer 10 and an upper shield layer 30. When a sense current 1 flows in a direction (Z-direction shown in the figure) perpendicular to the surface of each layer constituting the thin-film magnetic head element 20, the leakage flux from the storage medium is detected by using a magnetoresistive effect of the thin film magnetic head element 20.

As is well known in the art, a giant magnetoresistive element (GMR element) and a tunneling magnetoresistive element (TMR element), both of which exhibit the giant magnetoresistive effect, may be used as the thin-film magnetic head element 20.

The lower shield layer 10 and the upper shield layer 30 have an area even greater than the track width Tw and the height direction size MRh of the thin-film magnetic head element 20. The lower shield layer 10 and the upper shield layer 30 are composed of a soft magnetic material that exhibits a satisfactory magnetic shielding effect, for example, NiFe. The lower shield layer 10 and the upper shield layer 30 operate as the magnetic shield and a an electrode which feeds a power to the thin-film magnetic head element 20.

A side fill gap layer 40, a bias layer 41 and a cap layer 42 are disposed between the lower shield layer 10 and the upper shield layer 30 at both regions of the thin-film magnetic head element 20. The side fill gap layer 40, the bias layer 41 and the cap layer 42 are stacked sequentially from the lower shield layer 10. The side fill gap layer 40 is formed of an insulating material, for example, AI₂O₃ or SiO₂. The side fill gap layer 40 electrically insulates the lower shield layer 10 and the upper shield layer 30. The side fill gap layer 40 is formed in a very thin film thickness of about 150 Å or less. The bias layer 41 is formed of a hard magnetic material such as a Co—Pt alloy film or a Co—Cr—Pt alloy film and is disposed in vicinity of both end faces 20a in the track width direction of the thin-film magnetic element 20. The bias layer 41 applies a bias flux to a free magnetic layer. A bias underlying layer (not shown in figure) is formed directly below the bias layer 41 to improve the properties (coercive force and remanence ratio) of the bias layer 41 as not shown in the figure. The cap layer 42 is formed of, for example, Ta.

A back fill gap layer (not shown in figure) disposed in the height direction of the thin-film magnetic head element 20 and made of the insulating material, for example, AI₂O₃ or SiO₂ is formed on the lower shield layer 10.

In one embodiment, the top surface of the lower shield layer 10 is formed in the non-flat surface having a convex portion 10a disposed at the center in the track width direction and a concave portion 10b disposed at both sides in the track width direction of the convex portion 10a. The thin-film magnetic head element 20 is formed on the convex portion 10a of the lower shield layer 10 and an buried gap layer 50 contacting the side fill gap layer 40 is formed in the concave portion 10b of the lower shield layer 10. The top surface of the buried gap layer 50 and the top surface of the convex portion 10a of the lower shield layer 10 are in the same plane (flat surface). For example, the flatness of the top surfaces are higher than the lower shield layer 10 and the buried gap layer 50 are secured.

The buried gap layer 50 is formed of one or more types of insulating materials, for example, SiO₂, A1₂O₃, Ta₂O₅, TiO, Ti₂O₃, Ti₃O₅, WO₃, Si₃N₄, AlN, AlSiO or SiAlON. The insulating property of the lower shield layer 10 and the upper shield layer 30 is secured by the buried gap layer 50 and the side fill gap layer 40. The buried gap layer 50 is thicker than the side fill gap layer 40, and specifically, has the film thickness 3 times thicker than the side fill gap layer 40.

In one embodiment, the buried gap layer 50 is formed in a film thickness of approximately 500 Å. Since the side fill gap layer 40 is formed in a very thin thickness of 150 Å or less as described above, the defect such as the pin hole may occur, but the insulation failure caused by the defect of the side fill gap layer 40 can be evaded by contacting the buried gap layer 50 of a sufficient thickness to the side fill gap layer 40.

A region in which the side fill gap layer 40 and the lower shield layer 10 are directly contacted to each other, for example, a region in which the insulating property is secured only with the side fill gap layer 40 is narrowed by forming the buried gap layer 50. The probability that the insulation failure caused by the defect of the side fill gap layer 40 will occur decreases.

The convex portion loa of the lower shield layer 10 has the extension region in which the location of the both end faces 10c in the track width direction thereof extends outwardly from the location of the both end faces 20a in the track width direction of the thin-film magnetic head element 20. The size Tw2 in the track width direction of the extension region is 1/10 times to 20 times the track width of the thin-film magnetic head element 20. For example, it is preferable that the region in which the side fill gap layer 40 and the lower shield layer 10 are directly contacted to each other is not present. It is difficult to align the location of the both end faces of the convex portion 10a of the lower shield layer 10 with the location of the both end faces in the track width direction of the thin-film magnetic head element 20 with high precision.

In one embodiment, when the size Tw2 in the track width direction of the extension region of the lower shield layer 10 is about 1/10 times smaller than the track width of the thin-film magnetic head element 20, the alignment is not accomplished and the location of the both end faces of the lower shield layer 10 may be misaligned inwardly from the both end faces of the thin-film magnetic head element 20. When the location of the both end faces of the lower shield layer 10 is misaligned inwardly from the location of the both end faces of the thin-film magnetic head element 20, the effective track width of the thin-film magnetic head element 20 is reduced, thereby deteriorating the reproduction characteristic. When the size Tw2 in the track width direction of the extension region of the lower shield layer 10 is small, the shielding effect by the lower shield layer 10 is reduced. Therefore, a side reading may occur.

Alternatively, the size Tw2 in the track width direction of the extension region of the lower shield layer 10 is about 20 times greater than the track width of the thin-film magnetic head element 20, the region in which the lower shield layer 10 is in contact directly with the side fill gap layer 40 is broaden. Therefore, the probability that the insulation failure caused by the defect of the side fill gap layer 40 will occur increases.

In one embodiment, the extension region of the lower shield layer 10 in which the size Tw2 in the track width direction satisfies the range has the surface roughness of about 30 Å or less. In this embodiment, an occurrence of the pin hole on the side fill gap layer 40 stacked on the extension region of the lower shield layer 10 can be suppressed and the insulating property can be secured even if the lower shield layer 10 is in contact directly with the side fill gap layer 40 in the extension region.

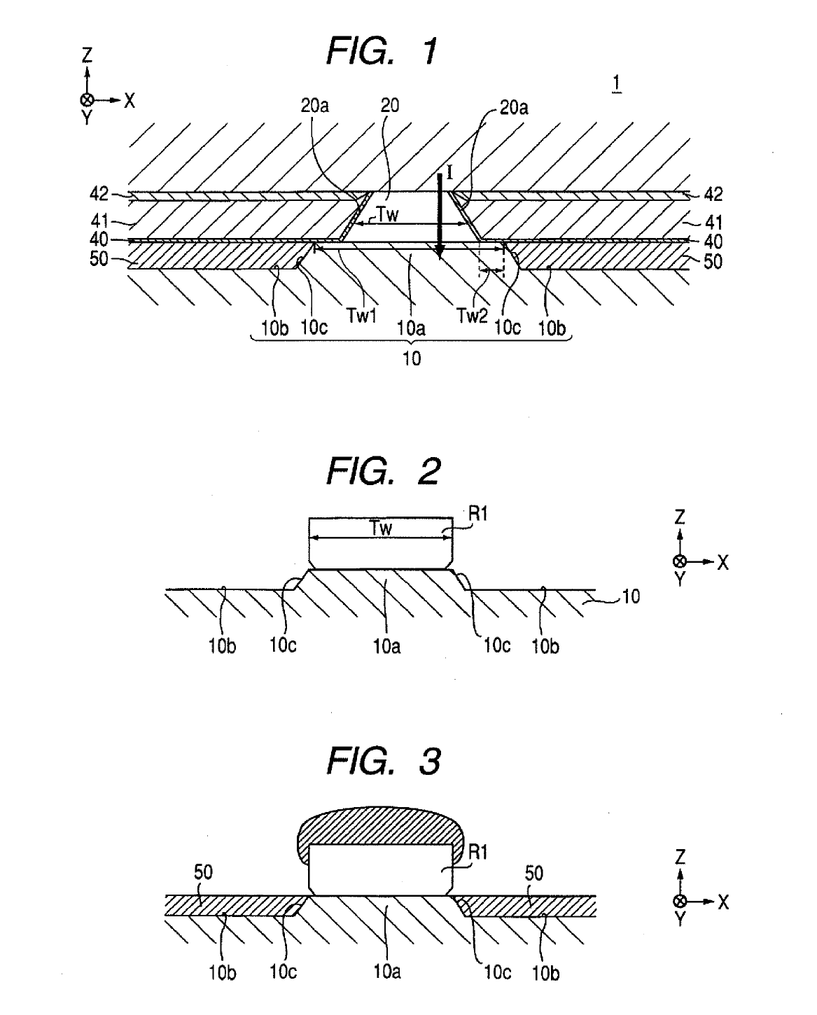

In another embodiment, a method of manufacturing the CPP-type shown in FIGS. 1 and 2 according to method will be described with reference to FIGS. 2 to 6.

As shown in FIG. 2, a substrate is completely coated with the lower shield layer 10 and a first resist Rl that defines the size Twl in the track width direction of the top surface of the lower shield layer 10 (convex portion 10a) is disposed at the center in the track width direction over the lower shield layer 10. The lower shield layer 10 is formed of the soft magnetic material such as NiFe and in the film thickness of approximately 1 μm by sputtering or plating. The first resist R1 is the liftoff resist. The size Tw1 in the track width direction of the top surface of the lower shield layer 10 is greater than the track width Tw of the thin-film magnetic head element to be formed (Tw1>Tw).

In one embodiment, as shown in FIG. 2, the lower shield layer 10 not covered with the first resist R1 is removed in a predetermined depth. The top surface of the lower shield layer 10 is formed in the non-flat surface having the convex portion 10a covered with the first resist R1 and the concave portion 10b disposed at both sides in the track width direction of the convex portion 10a. In this embodiment, the both end faces 10c in the track width direction of the convex portion 10a is formed in an inclined surface broadening the size of the lower shield layer 10 in the track width direction as the both end faces 10c are directed from the convex portion 10a to the concave portion 10b. The inclination angle of the both end faces 10c in the track width direction of the convex portion 10a can be controlled by an etching angle (milling angle) and a shape of the concave 19b is defined by shapes of the both end faces in the track width direction of the convex portion 10a. A depth in which the lower shield layer 10 not covered with the first resist R1 is removed, for example, the depth of the concave portion 10b is greater than the depth of the side fill gap layer 40 formed in the subsequent step and preferably, 3 times greater than the thickness of the side fill gap layer 40.

In one embodiment, as shown in FIG. 3, when the first resist remains the buried gap layer 50 is formed in the concave portion 10b of the lower shield layer 10. In the buried gap layer 50, the top surface of the buried gap layer 50 and the top surface of the convex portion 10a of the lower shield layer 10 have the film thickness to be in the same plane by using one or more types of insulating materials out of, for example, SiO₂, Al₂O₃, Ta₂O₅, TiO, Ti₂O₃, Ti₂O₅, WO₃, Si₃N₄, AlN, AlSiO and SiAlON. The shape of the concave portion 10b in which the buried gap layer 50, for example, the inclination angle of the both end faces 10c in the track width direction of the convex portion 10a of the lower shield layer 10 is controlled as described above, thereby flattening the top surface of the buried gap layer 50. The thickness of the buried gap layer 50 is substantially the same as the depth of the concave portion 10b. For example, the thickness of the buried gap layer 50 is greater than the thickness of the side fill gap layer 40 and preferably, 3 times greater than the thickness of the side fill gap layer 40.

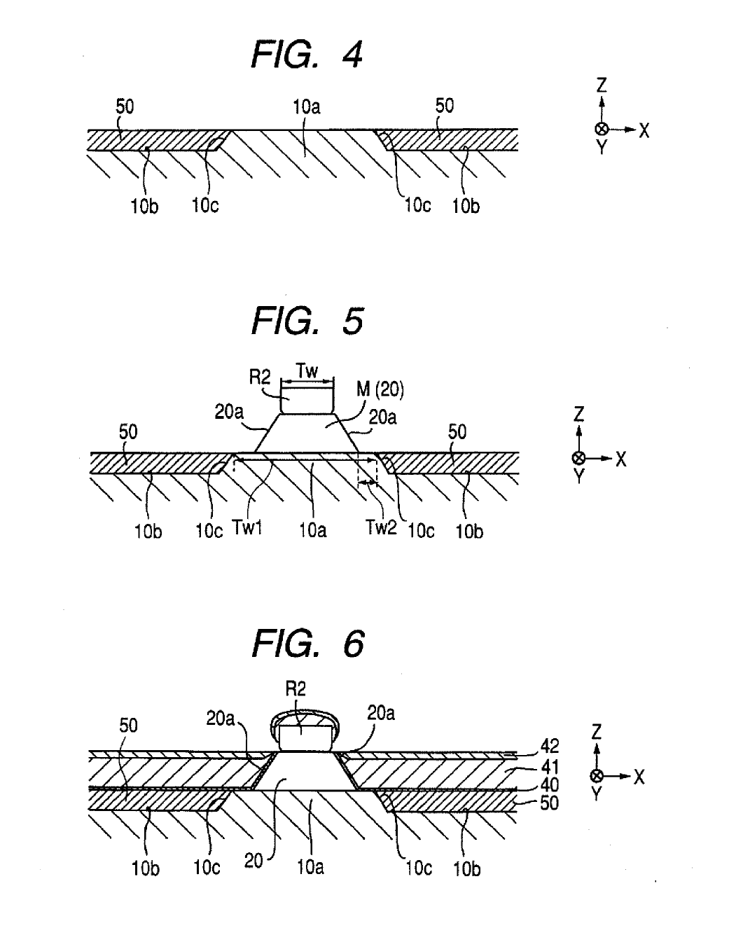

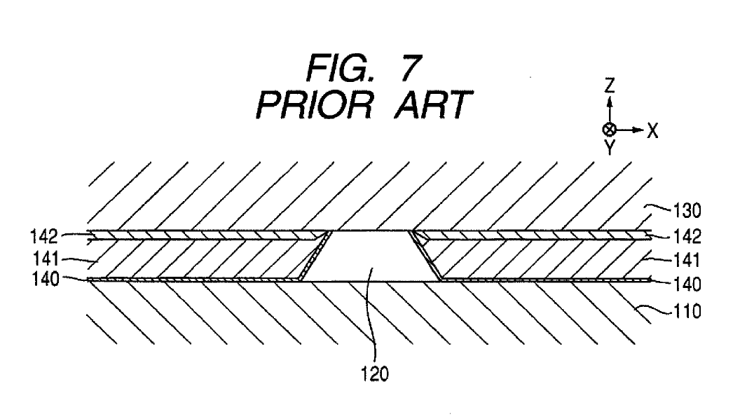

In one embodiment, the convex portion 10a of the lower shield layer 10 is exposed as shown in FIG. 4 by lifting off the first resist R1 after forming the buried gap layer 50.

In one embodiment, as shown in FIG. 5, a multilayer film M which exhibits the magnetoresistive effect is formed on the convex portion 10a and the buried gap layer 50 of the lower shield layer 10. A second resist R2 which defines the track width Tw of the thin-film magnetic head element is formed on the multilayer film M. The second resist R2 is the liftoff resist. The track width Tw of the thin-film magnetic head element to be formed is smaller than the size Tw1 in the track width direction of the top surface of the convex portion 10a of the lower shield layer 10 (Tw1>Tw). The size Tw1 in the track width direction of the top surface of the lower shield layer 10 is greater than the track width Tw of the thin-film magnetic head element to be formed (Tw1>Tw).

In one embodiment, as shown in FIG. 5, when the second resist R2 is formed, the multilayer film M not covered with the second resist R2 is removed by the etching process such as the milling, and the convex portion 10a and the buried gap layer 50 are exposed in the lower shield layer 10. The location of the both end faces in the track width direction of the convex portion 10a of the lower shield layer 10 extends from the location of the both end faces in the track width direction of the thin-film magnetic head element 20. The extension region is exposed in the removed part.

In this embodiment, the size of the top surface of the convex portion 10a in the track width direction is pre-defined so that the size Tw2 in the track width direction of the extension region of the convex portion 10a is about 1/10 times to 20 times the track width Tw of the thin-film magnetic head element 20. In this embodiment, the multilayer film (multilayer film covered with the second resist R2) M disposed on the convex portion 10a of the lower shield layer 10 becomes the thin-film magnetic head element 20.

In one embodiment, as shown in FIG. 6, when the second resist R2 remains as it is, the side fill gap layer 40, the bias layer 41 and the cap layer 42 are stacked sequentially from the both end faces 20 in the track width direction of the thin-film magnetic head element 20 to the convex portion 10a and the buried gap layer 50 of the exposed lower shield layer 10. The bias layer 41 is formed of the hard magnetic material, for example, the Co—Pt alloy film or the Co—Cr—Pt alloy film. After the cap layer 42 is formed, the second resist R2 is lifted off.

In one embodiment, a third resist which defines the height of the thin-film magnetic head element 20 is formed on the thin-film magnetic head element 20. The thin-film magnetic head element 20 not covered with the third resist is removed by the etching process. The back fill gap layer is formed in the removed part. After the back fill gap layer is formed, the third resist is lifted off.

In one embodiment, an upper shield layer 30 is formed on the thin-film magnetic head element 20, the cap layer 42 and the back fill gap layer. The upper shield layer is formed of the soft magnetic material, for example, NiFe and in the film thickness of approximately 1 μm by sputtering or plating.

As described above, the present embodiments were applied to a reproducing thin-film magnetic head, but the present embodiments can be also applied to, for example, the recording/reproducing thin-film magnetic head in which a recording inductive head is stacked on the reproducing thin-film magnetic head.

Various embodiments described herein can be used alone or in combination with one another. The forgoing detailed description has described only a few of the many possible implementations of the present invention. For this reason, this detailed description is intended by way of illustration, and not by way of limitation. It is only the following claims, including all equivalents that are intended to define the scope of this invention.

What is claimed is:

1. A CPP-type thin-film magnetic head comprising: a thin-film magnetic head element formed between the lower shield layer and the upper shield layer and a side fill gap layer that secures the insulating property of the lower shield layer and the upper shield layer,
wherein the side fill gap layer is formed over both side regions of the thin-film magnetic head in a track width direction, comprising an end face of the film magnetic head and an upper face of the lower shield layer in the common side of the end face, and
wherein the top surface of the bottom shield layer is formed in a non-flat surface having a convex portion disposed at a center in the track width direction and a concave portion disposed at both sides in the track width direction of the convex portion, the thin-film magnetic element is formed on the convex portion, and a buried gap layer contacting the side fill gap layer is formed in the concave portion.

2. The CPP-type thin-film magnetic head according to claim 1, wherein the buried gap layer is thicker than the side fill gap layer.

3. The CPP-type thin-film magnetic head according to claim 1, wherein the convex portion of the lower shield layer has an extension region that extends outwardly from the both end faces of the thin-film magnetic head element and contacting the side fill gap layer, and the size of the extension region in the track width direction is about 1/10 times to 20 times the track width of the thin-film magnetic head element.

4. The CCP-type thin-film magnetic head according to claim 3, wherein the extension region of the lower shield layer has a surface roughness of about 30 Å or less.

5. The CCP-type thin-film magnetic head according to claim 1, wherein the top surface of the convex portion of the lower shield layer and the top surface of the buried gap layer formed in the concave portion of the lower shield layer are in the same plane.

6. The CCP-type thin-film magnetic head according to claim 1, wherein the buried layer is formed of one or more types of insulating materials.

7. The CCP-type thin-film magnetic head according to claim 1, wherein a bias layer and a cap layer are sequentially stacked from the side fill gap layer side and are interposed between the side fill gap layer and the upper shield layer.

8. A method of manufacturing a CPP-type thin-film magnetic head comprising:
forming a first liftoff resist which defines a track width of a top surface of a lower shield layer, the first liftoff resist being disposed at the center in the track width direction of the lower shield layer;
forming the top surface of the lower shield layer with a non-flat surface having the convex portion covered with the resist and the concave portion disposed at both sides in the track width direction of the convex portion by removing the lower shield layer not covered with the first resist up to a predetermined depth;
forming a buried gap layer in the concave portion of the lower shield layer;
exposing the convex portion of the lower shield layer by lifting off the first resist;
forming a multilayer film constituting the thin-film magnetic head element on the convex portion and the buried gap layer of the lower shield layer;
forming a second liftoff resist which defines the track width of the multilayer film;
forming the multilayer film covered with the second resist layer with the thin-film magnetic head element by removing the multilayer film not covered with the second resist, and exposing a part of the convex portion and the buried gap layer of the lower shield layer to the removed par;
forming the side fill gap layer, bias layer and cap layer on both end faces in the track width direction of the thin-film magnetic head element, and the exposed convex portion and buried gap layer of the lower shield layer;
exposing the top surface of the thin-film magnetic head element by lifting off the second resist; and
forming the upper shield layer on the thin-film magnetic head element.

9. The method of manufacturing the CCP-type thin-film magnetic head according to claim 8, wherein the lower shield layer that is not covered with the first resist is sharpened by etching and an inclination angle of the both end faces in the track width direction of the convex portion of the lower shield layer by an etching angle, thereby flattening the top surface of the buried gap layer formed in the concave portion of the lower shield layer.

10. The method of manufacturing the CCP-type-thin film magnetic head according to claim 8, wherein the lower shield layer that is not covered with the first resist is sharpened to a depth greater than the thickness of the side fill gap layer.

11. The method of manufacturing the CCP-type thin-film magnetic head according to claim 8, wherein the size of the top surface of the lower shield layer in the track width direction is greater than the track width of the thin-film magnetic head element.

12. The method of manufacturing the CCP-type thin-film magnetic head, wherein the extension region that extends from the both end faces of the thin-film magnetic head element contacting the side fill gap layer is formed, and the size in the track width direction is about 1/10 times to 20 times the size of the thin-film magnetic head element in the track width direction.

13. The method of manufacturing the CCP-type thin-film magnetic head according to claim 8, wherein the buried layer is formed of one or more types of insulating materials.

14. A CPP-type thin-film magnetic according to claim 1, wherein a current flows in a direction perpendicular to a film surface of the thin-film magnetic head element.

15. The CCP-type thin-film magnetic head according to claim 6, wherein the buried layer is formed of one or more of SiO₂, Al₂O₃, Ta₂O₅, TiO, Ti₂O₃, Ti₃O₅, WO₃, Si₃N₄, AlN, AlSiO or SiAlON.

16. The method of manufacturing the CCP-type thin-film magnetic head according to claim 13, wherein the insulating materials are SiO₂, Al₂O₃, Ta₂O₅, TiO, Ti₂O₃, Ti₃O₅, WO₃, Si₃N₄, AlN, AlSiO or SiAlON.

17. The method of manufacturing the CCP-type thin-film magnetic head according to claim 11, wherein both end faces in the track width direction of the convex portion of the lower shield layer are disposed outwardly from the both end faces in the track width direction of the thin-film magnetic head element.

18. The method of manufacturing the CCP-type-thin film magnetic head according to claim 10, wherein the buried gap layer has a film thickness so that the top surface of the buried gap layer and the top surface of the lower shield layer are in the same plane.

19. A CCP-type thin-film magnetic head comprising:
a thin-film magnetic head element formed between the upper shield layer and the lower shield layer, and
a side fill gap layer, which is formed from both end faces of the thin-film magnetic head element,
wherein a top surface of the lower shield layer is formed in a non-flat surface that has a convex portion disposed at a center in a track width direction and a concave portion disposed at both sides in a track width direction of the convex portion, the thin-film magnetic head element is formed on the convex portion, and a buried gap layer contacting the side fill gap layer is formed in the concave portion.
